(19) United States
(12) Patent Application Publication
(10) Pub. No.: US 2012/0135190 A1
(43) Pub. Date: May 31, 2012

(54) Article Having a Selectively Texturable Surface and Method of Using

(75) Inventors: Alan L. Browne, Grosse Pointe, MI (US); Nancy L. Johnson, Northville, MI (US)

(73) Assignee: GM GLOBAL TECHNOLOGY OPERATIONS, INC., DETROIT, MI (US)

(21) Appl. No.: 12/956,534

(22) Filed: Nov. 30, 2010

(51) Int. Cl. B32B 3/00; B29C 67/00

(52) U.S. Cl. 428/141; 264/299

(57) ABSTRACT

An article that has a texturable surface, i.e., a surface whose texture may be non-reversibly or reversibly configured, is provided. The article includes a selectively texturable surface, the texturable surface having a first surface texture associated with a first activation condition and a second surface texture associated with a second activation condition, wherein the first surface texture is different than the second surface texture. The article also includes an activation condition responsive material comprising an active material or a thixotropic material, or a combination thereof, which is operatively associated with the texturable surface and configured to provide the first surface texture in the first activation condition and the second surface texture in the second activation condition.

### FIELD OF THE INVENTION

Exemplary embodiments of the present invention are related to an article having a texturable surface, and more particularly, to an article having a texturable surface that comprises an activation condition responsive material, and even more particularly to an article having a texturable surface that comprises an activation condition responsive material that is responsive to a change in moisture content or an applied shear force.

### BACKGROUND

Many articles have surfaces that have an undesirable response, such as a decrease in the coefficient of sliding friction when exposed to increased amounts of moisture, such as when they become wet or are otherwise exposed to increased amounts of moisture. One example include tires for various application, where exposure of the tread surface to moisture reduces the coefficient of sliding friction with respect to the surface over which the tire is traveling and may result in undesirable tire performance, such as an increased stopping distance or reduced cornering performance. Other examples include non-skid surfaces used in various articles of manufacture used in vehicles, including door liners, non-skid surface appliqués, flooring, bed liners, pedals, pedal covers or pads, steering wheels, steering wheel covers and the like, as well as non-vehicular articles of manufacture, including various floor coverings, door liners, non-skid surface appliqués, flooring, bed liners, covers and pads, where exposure of the surface to moisture generally reduces the coefficient of sliding friction, and may make the surface undesirably slippery.

In such articles, changes in the coefficient of sliding friction of the articles surfaces in response to changes in their moisture condition are generally not controlled, so it would be desirable to provide surfaces with a selectively controllable friction performance in response to changes in the moisture condition of the surface, such as, for example, by maintaining a predetermined level of friction in response to an increase in the amount of moisture at the surface.

Accordingly, it is desirable to provide articles having surfaces that have a selectively controllable response to changes in the moisture condition of the surface.

### SUMMARY OF THE INVENTION

In one exemplary embodiment, an article comprising a selectively texturable surface is provided. The article has a selectively texturable surface, the selectively texturable surface having a first surface texture associated with a first activation condition and a second surface texture associated with a second activation condition, wherein the first surface texture is different than the second surface texture. The article also includes an activation condition responsive material comprising an active material, a xerogel, a thixotropic material or a shear thickening material.

In another exemplary embodiment, an article comprising a moisture-activated, selectively texturable surface is provided. The article has a moisture-activated, selectively texturable surface, the selectively texturable surface having a first surface texture associated with a first moisture content proximate the surface and a second surface texture associated with a second moisture content proximate the surface, wherein the first surface texture is different than the second surface texture. The article also includes an active material operatively associated with the selectively texturable surface, the active material having a first condition associated with the first moisture content and a second condition associated with the second moisture content, wherein the first condition is configured to selectively provide the first surface texture and the second condition is configured to provide the second surface texture.

In another exemplary embodiment, a method of making an article comprising a texturable surface is provided. The method includes forming an article having a selectively texturable surface, the selectively texturable surface having a first surface texture associated with a first activation condition and a second surface texture associated with a second activation condition wherein the first surface texture is different than the second surface texture, from an activation condition responsive material comprising an active material, a thixotropic material or a shear thickening material, or a combination thereof, that is operatively associated with the selectively texturable surface and configured to provide the first surface texture in the first activation condition and the second surface texture in the second activation condition. The method also includes exposing the selectively texturable surface to one of the first activation condition or the second condition to provide one of the first surface texture or the second surface texture.

The above features and advantages and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1A-1D are schematic cross-sectional illustrations of an exemplary embodiment of a selectively texturable article and method of making and using the same as disclosed herein;

FIG. 2A-2D are schematic cross-sectional illustrations of a second exemplary embodiment of a selectively texturable article and method of making and using the same as disclosed herein;

FIG. 3A-3C are schematic cross-sectional illustrations of a third exemplary embodiment of a selectively texturable article and method of making and using the same as disclosed herein;

FIG. 4 is an exemplary embodiment of an article having a selectively texturable surface that is configured to be actively selectively texturable; and

FIG. 5 is a flow chart of a method of using a selectively texturable article as disclosed herein.

### DESCRIPTION OF THE EMBODIMENTS

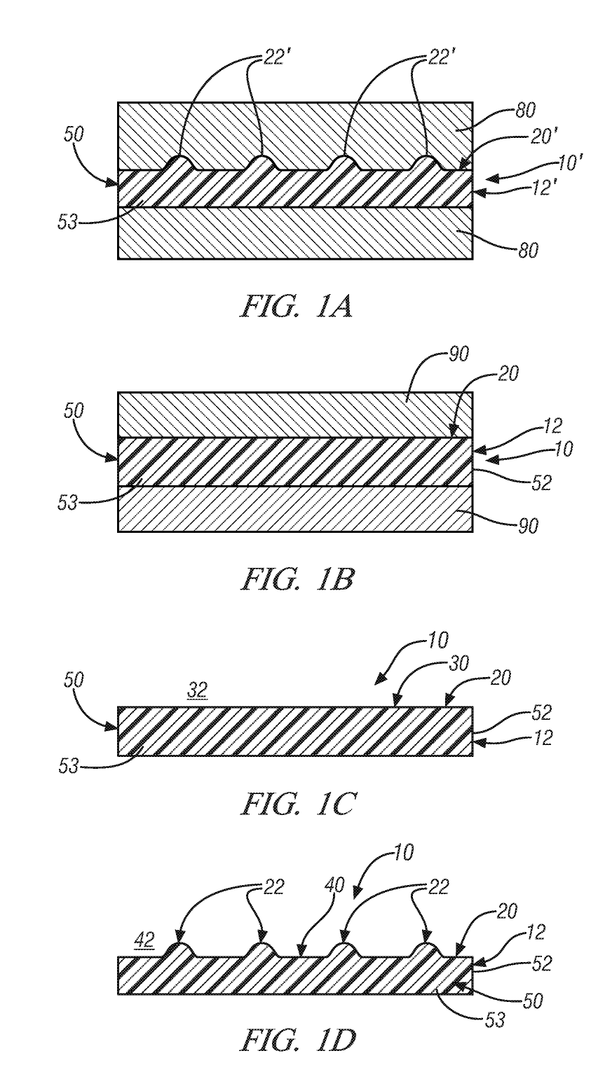

Referring to the FIGS. 1A to 1D, in accordance with an exemplary embodiment of the present invention an article 10 that includes a selectively texturable surface 20 and comprises a body 12 is provided, as well as a method of making and using the article 12. The article 10 may be any suitable article 10 where it is desirable to provide a selectively texturable surface 20 as described herein. The selectively texturable surface 20 is configured to be selectively changed from a first surface texture 30 (FIG. 1C) to a second surface texture 40 (FIG. 1D). The selective change of the surface texture may be used to select the properties and performance characteristics of the surface 20 in various applications. In an exemplary embodiment, this may include a selective increase or decrease in the coefficient of sliding friction in response to a change from a first activation condition 32 and associated first surface texture 30 to a second activation condition 42 and associated second surface texture 40. In other exemplary embodiments, this may include a selective increase or decrease in the tractive characteristics of the surface 20, or more generally, the force transmission characteristics of the surface 20 against a mating surface or medium (e.g., a fluid) with which it is in contact in response to a change from a first activation condition 32 and associated first surface texture 30 FIG. 1C) to a second activation condition 42 and associated second surface texture 40 (FIG. 1D). One example of an article 10 includes tires for various applications, where exposure of the tread surface to moisture produces a change in the surface texture and increases the coefficient of sliding friction with respect to the surface over which the tire is traveling and provides performance advantages, such as a reduced stopping distance or increased cornering performance. Other examples of articles 10 include non-skid surfaces 20 used in various articles of manufacture used in various vehicles, including door liners, non-skid surface appliqués, flooring, bed liners, pedals, pedal covers or pads, steering wheels, steering wheel covers and the like, as well as non-vehicular articles of manufacture, including various floor coverings, door liners, non-skid surface appliqués, flooring, bed liners, covers and pads, where exposure of the surface to moisture produces a change in the surface texture and increases the coefficient of sliding friction to make the surface less slippery.

Selectively texturable surface 20 is configured to provide a first surface texture 30 associated with a first activation condition 32 as shown in FIG. 1C where the first activation condition 32 is exposure of the surface 20 to a reduced amount of moisture (e.g., where the surface 20 is dry). Selectively texturable surface 20 is also configured to provide a second surface texture 40 associated with a second activation condition 42 as shown in FIG. 1D where the second activation condition 42 is exposure of the surface 20 to an increased amount of moisture (e.g., where the surface 20 is wet or exposed to a high humidity environment). The increased moisture may be in the form of exposure to liquid water or an increase in the moisture content of the environment proximate the surface, such as, for example, a high humidity condition. In this example, the second surface texture 40 is greater than the first surface texture 30 by virtue of the plurality of protrusions 22 formed on the surface 20. In the second activation condition 42 the protrusions 22 protrude from the surface 20 and provide increased surface texturing, whereas in the first activation condition 32 the surface 20 has a reduced amount of texturing because the protrusions 22 are not present, or reduced in size (not shown).

The first surface texture 30 is different than the second surface texture 40. The difference may include macroscopic differences or aspects such as, for example, the volume, contour or shape of texturable surface 20, or it may include microscopic differences or aspects such as, for example, the surface roughness, porosity, or microscopic profile, contour or shape features, or it may include a combination of macroscopic and microscopic differences.

This change in texturing may be used, for example, to increase or decrease the coefficient of sliding friction at the interface between the texturable surface and objects with which it is in contact. Another embodiment includes the incorporation of films of thixotropic fluids in subsurface layers to allow the surface to reversibly conform to the shape of the object locally stressing the surface—such as a hand gripping a steering wheel—so as to enhance the grip/shear forces between the two. Applications and embodiments include, but are not limited to, moisture activated SMP texturing for passive reduction in the slipperiness of wet surfaces, such as floors or otherwise smooth surfaced floor coverings or brake, gas or other pedals and the like; moisture and heat activated texturing of various grips, such as a tennis racquet grip; moisture activated texturing (e.g., moisture from hands) or shear force activated texturing of a steering wheel or other human contact surface; automatic texturing of tire surfaces when wet; and the use of a moisture sensor to trigger texturing, whether performed with an SMP or non-SMP approach. Reverse embodiments, in which moisture-activation is used to reduce the magnitude of the surface texture with an increase in the amount of moisture present at the selectively texturable surface 20 and thus enhance the ease of surface cleaning, are also comprehended.

Referring to FIGS. 1A-3D, article 10 also includes an activation condition responsive material 50. The activation condition responsive material is operatively associated with the texturable surface 20 and configured to provide the first surface texture 30 in the first activation condition 32 and the second surface texture 40 in the second activation condition 42. The change in texture may be reversible (two-way texturing) or non-reversible (one-way texturing). The activation condition responsive material 50 may include any suitable condition responsive material 50 and may be configured to respond to any suitable activation condition that is configured to provide a change in the texturable surface 20, or to a plurality of activation conditions. Suitable activation condition responsive materials include an active material 52, such as a shape memory polymer (SMP) material 53, a xerogel material 54, a thixotropic material 56 or a shear thickening material 58, or a combination thereof. Activation condition responsive materials 50 may use or employ a variety of one-way mechanisms or reversible, two-way mechanisms to provide the change in the surface texture. In one exemplary embodiment, activation condition responsive materials 50 may include an active material 52, including an SMP material 53 that employs a non-reversible or reversible moisture-activated shape memory effect exhibited by certain classes of shape memory polymers (SMP) wherein portions of the SMP that have been trained by suitable forming methods provide a dimensional change that is activated by a change in the amount of moisture to which the texturable surface 20 is exposed. In another exemplary embodiment, activation condition responsive material 50 may include a xerogel that provides a fluid (e.g., water) activated reversible dimensional change, such as, for example, expansion and contraction upon the uptake and loss, respectively, of a fluid to provide a reversible texturing of texturable surface 20. In yet another exemplary embodiment, activation condition responsive material 50 may include a thixotropic material 56 or a shear thickening (or thinning) material 58 (e.g., shear thickening fluid 58) that employs a change in the viscocity of the material in response to an applied stress, wherein the application and removal of a stress applied to the texturable surface 20 may be used to change its texture.

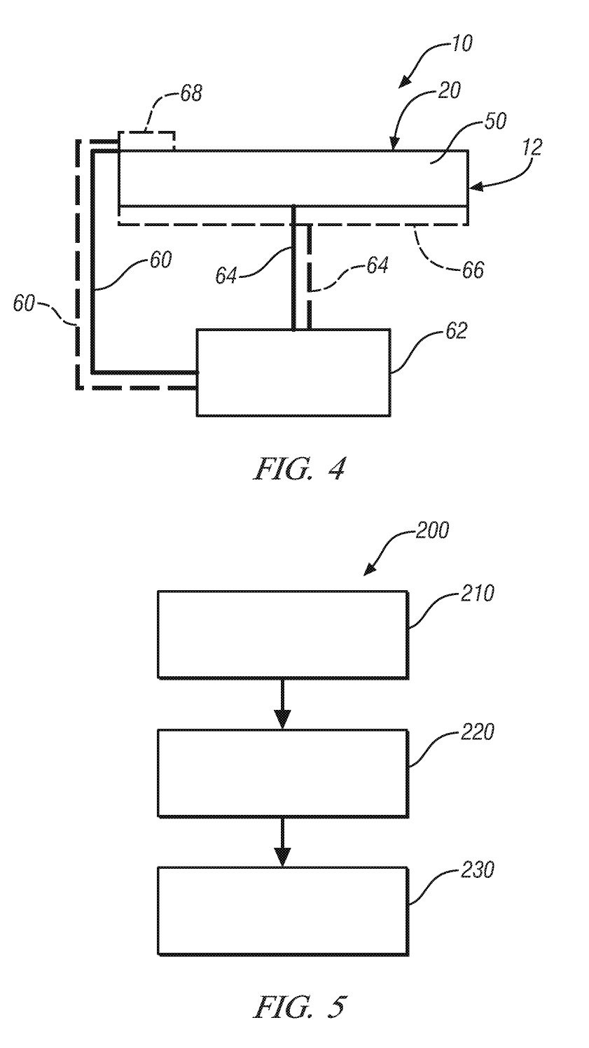

Activation condition responsive material 50 may provide the response to the first activation condition 32 and second activation condition 42 either passively, as in the examples described above, or actively in response to a sensed signal 60, FIG. 4, indicative of the first and second conditions 32, 42. The sensed signal 60 may be provided from the activation condition responsive material 50 directly, or optionally by employing an appropriate sensor 68 that is operative to sense a first activation condition 32 and a second activation condition 42. As shown in FIG. 4, when the response to these conditions is provided actively, the response and change of the activation condition responsive material 50 may be controlled by a controller 62, such as a micro computer-based controller, to provide an activation signal 64 that is configured to produce the activation condition needed to activate the activation condition responsive material 50. In some embodiments, the activation condition may be produced in the activation condition responsive material 50 by the activation signal 64 alone, such as active materials that may be activated directly by an activation signal 64, including various electrical signals. In other embodiments, the activation condition may optionally be produced in the activation condition responsive material 50 by the activation signal 64 and an activation device 66, such as a heater for thermal responsive materials, or a device that is configured to produce an electrical or magnetic field for materials that are responsive to electrical or magnetic fields. In one example, the activation condition responsive material 50 may be used to directly generate a sensed signal 60 that is indicative of a first moisture or stress condition 32 or second moisture or stress condition 42, or both, and the controller 62 may be used to actively and directly control the activation condition responsive material 50 to provide a first surface texture 30 or a second surface texture 40 using the signal 60. In another example, a sensor 68 operatively engaged with the activation condition responsive material 50 may used to indirectly generate a signal 60 that is indicative of a first moisture or stress condition 32 or second moisture or stress condition 42, or both, and the controller 62 may be used to control an activation device 66 to activate the activation condition responsive material 50 to provide a first surface texture 30 or a second surface texture 40 using the signal 60.

As used herein, the term “active material” refers to materials that exhibit a shape memory effect. Specifically, after being deformed pseudo-plastically, they can be restored to their original shape by appropriate activation. In this manner, shape memory materials can change to a predetermined shape either passively or actively in response to an activation condition, including an activation signal, and more particularly an activation condition comprising exposure of the material to a suitable fluid, and more particularly an activation condition comprising exposure of the material to moisture. It is these properties that advantageously will provide texturable surface 20. Suitable shape memory materials include, without limitation, various SMP materials, and more particularly, various fluid activated SMP materials, including moisture activated SMP materials.

“Shape memory polymer” generally refers to a polymeric material, which exhibits a change in a property, such as an elastic modulus, a shape, a dimension, a shape orientation, or a combination comprising at least one of the foregoing properties either actively upon application of an activation signal or passively in response to a change in an environmental condition (e.g., moisture content). In passively activated systems, the shape memory polymers may include any suitable SMP, particularly a fluid activated SMP, and more particularly a moisture activated SMP, where the change in the property is caused passively by exposure of the SMP to a suitable fluid, such as water. The SMP and fluid will be selected to provide the desired property change, such as those described herein. In actively activated systems, a fluid activation signal from a controller 62, such as one indicative of exposure of the material to a suitable or predetermined fluid, may be used to control activation of the active material. In these systems, the SMP may be selected to be thermoresponsive (i.e., the change in the property is caused by a thermal activation signal or in response to a change in a thermal condition, such as a change in temperature) or photoresponsive (i.e., the change in the property is caused by a light-based activation signal or a in response to a change in a lighting condition, such as a change in the wavelength or intensity of incident light) or any other suitable SMP property change mechanism. The activation signal 64 may be provided in response to a sensed signal 60 that is responsive to exposure of the active material (e.g., SMP) to a predetermined fluid. This may include sensed signals responsive to any property of the fluid. In the case of water, this property may include the humidity, water vapor pressure, or presence of liquid water or another response to a change in a water-related condition, such as the presence or absence of water or a change in the relative amounts or phase of the water, or a combination comprising at least one of the foregoing.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which is copolymerized to form the SMP. Each segment may be crystalline or amorphous and will have a corresponding melting point or glass transition temperature (T_{g}), respectively. The term “thermal transition temperature” is used herein for convenience to generically refer to either a T_{g} or a melting point (Tₘ) depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures (Tₜᵣₐₙₛ). The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP material is heated above the last transition temperature, the material can be imparted a permanent shape. A permanent shape for the SMP material can be set or memorized by subsequently cooling the material below that temperature. As used herein, the terms “original shape”, “previously defined shape”, and “permanent shape”, when referring to SMP materials are synonymous and are intended to be used interchangeably. A temporary shape can be set by heating the material to a temperature higher than a thermal transition temperature of any soft segment yet below the last transition temperature, applying an external stress or load to deform the SMP material, and then cooling below the particular thermal transition temperature of the soft segment while maintaining the deforming external stress or load. This is illustrated schematically in FIGS. 1A and 1B, where an SMP material 53 is molded in a mold 80 to produce a precursor article 10′ that includes precursor body 12′ having a precursor texturable surface 20′ that has precursor protrusions 22′ as illustrated in FIG. 1A. Precursor protrusions 22′ may have any suitable protruding form or shape including discrete circular (or other shape) bumps, elongated ridges or the like. The as-molded shape of FIG. 1A may then be pressed by a heated platen or platens 90 as shown in FIG. 1B to form the permanent shape of article 10 where the texturable surface 20 is flat and represents the first surface texture 30 in the first activation condition 32, such as a first moisture level that represents ambient atmospheric moisture in the form of water vapor, where texturable surface 20 is substantially planar. Upon exposure to the second activation condition 42, such as exposure to moisture comprising liquid water as described herein, texturable surface 20 assumes the as-molded configuration and the second surface texture 40 includes protrusions 22.

A temporary shape can be set in a moisture-responsive SMP material by exposing specific functional groups or moieties to moisture (e.g., humidity, water, water vapor, or the like) effective to absorb a specific amount of moisture, applying a load or stress to the moisture-responsive SMP material, and then removing the specific amount of moisture while still under load. To return to the original shape, the moisture-responsive SMP material may be exposed to moisture (with the load removed). The permanent shape may be recovered with the stress or load removed by either exposing the material to a fluid (e.g., moisture) or heating the material above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMP materials will demonstrate transitions between multiple temporary and permanent shapes.

For SMP materials with only two segments, the temporary shape of the shape memory polymer is set at the first transition temperature or is not exposed to moisture, or both, followed by cooling of the material, while under load, to lock in the temporary shape. The temporary shape is maintained as long as the SMP material remains below the first transition temperature or is not exposed to moisture, or both. The permanent shape is regained with the load removed when the SMP material is exposed to a fluid, more particularly to moisture, or once again brought above the first transition temperature (i.e., temperature-activated). Repeating the heating, shaping, and cooling steps can repeatedly reset the temporary shape.

Most SMP materials exhibit a “one-way” effect, wherein the material exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP material exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other.

The SMP materials may be activated by exposure to any suitable fluids, and more particularly to moisture, and even more particularly by effectively lowering their T_{g}. Indirect actuation of the shape-memory effect by lowering Tₜᵣₐₙₛ has been shown for commercially available polyurethanes, including polyurethane composites comprising carbon nanotubes. The temporary shape is programmed by conventional methods for thermally induced shape-memory polymers. When immersed in water, moisture diffuses into the polymer sample and acts as a plasticizer, resulting in recovery of the programmed shape. In the polymers and composites based on polyurethanes, T_{g} is lowered by immersion in water, such as for example from 35° C. to below ambient temperature. It has been shown that the lowering of T_{g} depends on the moisture uptake, which in turn depends on the immersion time. In time-dependent immersion studies, it has been shown that the water uptake can be adjusted between 0-4.5 wt. %, which goes along with a lowering of T_{g} of between 0 K° and 35 K°. As the maximum moisture uptake achieved after 240 hours was around 4.5 wt. %, this shape-memory polymer still has to be understood as a polymer and not as a hydrogel. A different strategy for water-actuated shape-memory polymers has been realized in polyetherurethane polysilesquisiloxane block copolymers. Here, low molecular weight poly(ethylene glycol), or PEG, has been used as the polyether segment. Upon immersion in water, the PEG segment dissolves, resulting in the disappearance of Tₘ and recovery of the permanent shape. See “Shape Memory Polymers”, Materials Today, Vol. 10, No. 4, p. 20-28, April 2007.

In the case of actively activated systems using thermoresponsive SMP materials, by changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent of the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMP materials in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP material can be selected to provide stress-induced yielding, which may be used directly (i.e. without heating the SMP material above its thermal transition temperature to ‘soften’ it) to make the pad conform to a given surface. The maximum strain that the SMP material can withstand in this case can, in some embodiments, be comparable to the case when the material is deformed above its thermal transition temperature.

Although reference has been, and will further be, made to thermoresponsive SMP materials, those skilled in the art in view of this disclosure will recognize that photoresponsive SMP materials and SMP materials activated by other methods may readily be used in addition to or substituted in place of thermoresponsive SMP materials. For example, instead of using heat, a temporary shape may be set in a photoresponsive SMP material by irradiating the photoresponsive SMP material with light of a specific wavelength (while under load) effective to form specific crosslinks and then discontinuing the irradiation while still under load. To return to the original shape, the photoresponsive SMP material may be irradiated with light of the same or a different specific wavelength (with the load removed) effective to cleave the specific crosslinks.

This illustrates that SMP materials may be selected to provide a broad range of passive environmental conditions or actively induced conditions that may be used as first condition 32 to obtain first surface texture 30 and second condition 42 to obtain second surface texture 40.

Suitable shape memory polymers, regardless of the particular type of SMP material, can be thermoplastics, thermoset-thermoplastic copolymers, interpenetrating networks, semi-interpenetrating networks, or mixed networks. The SMP material “units” or “segments” can be a single polymer or a blend of polymers. The polymers can be linear or branched elastomers with side chains or dendritic structural elements. Suitable polymer components to form a shape memory polymer include, but are not limited to, polyphosphazenes, poly(vinyl alcohols), polyamides, polyimides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), poly (ethylene vinyl acetate), polyethylene, poly(ethylene oxide)-poly(ethylene terephthalate), polyethylene/nylon (graft copolymer), polycaprolactones-polyamide (block copolymer), poly(caprolactone) diniethacrylate-n-butyl acrylate, poly(norbornyl-polyhedral oligomeric silsequioxane), polyvinylchloride, urethane/butadiene copolymers, polyurethane-containing block copolymers, styrene-butadiene block copolymers, and the like. In one exemplary embodiment, where moisture activation of the SMP is desirable, various urethanes may be employed as activation condition responsive material 50. The polymer(s) used to form the various segments in the SMPs described above are either commercially available or can be synthesized using routine chemistry. Those of skill in the art can readily prepare the polymers using known chemistry and processing techniques without undue experimentation.

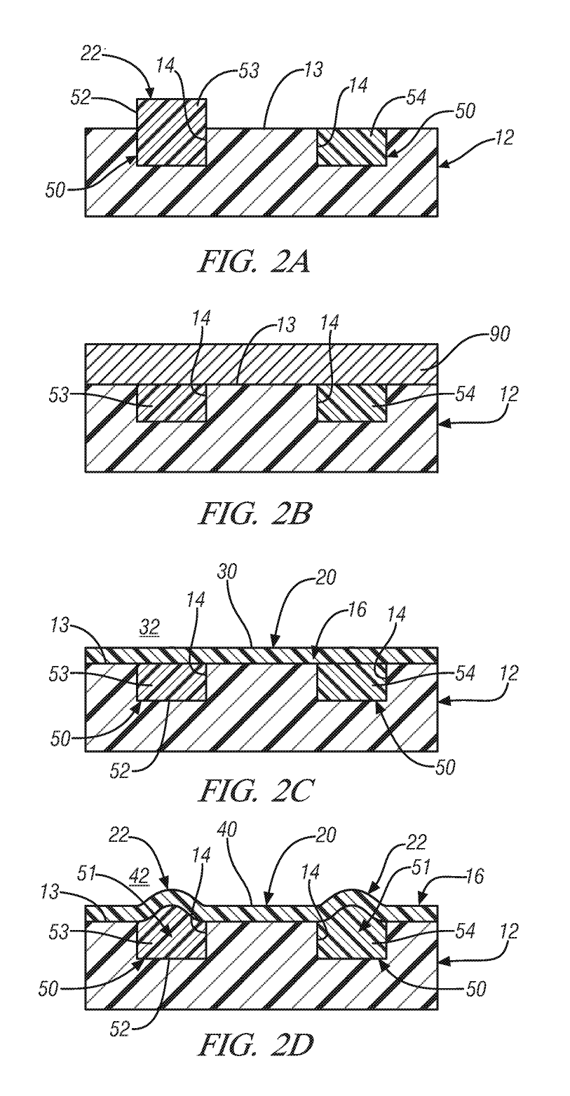

Referring to FIG. 2A-2D, an article 10 that includes a selectively texturable surface 20 comprises a body 12, FIGS. 2C and 2D. Body 12 includes a pocket 14 that houses activation condition responsive material 50, and may also include a plurality of pockets 14 that each house activation condition responsive material 50. A suitable activation condition responsive material 50 (or plurality of materials 50) is configured to provide a volume change, preferably a substantial volume change, upon exposure to a suitable activation fluid 51. An elastic, fluid permeable membrane 16 is configured to allow the desired activation fluid 51 to pass into and out of the pocket 14 to contact activation condition responsive material 50 and the activation condition responsive material 50 is operatively associated with the moisture permeable layer so that upon expansion the material acts against the elastic membrane 16, thereby elastically deforming the membrane and providing a protrusion 22. Therefore, in a first activation condition 32 where the texturable surface 20 has not been exposed to an activation fluid 51 the first surface texture 30 is provided wherein the texturable surface 20 is substantially planar as shown in FIG. 2C. In a second activation condition 42 where the texturable surface 20 has been exposed to activation fluid 51 the second surface texture 40 is provided wherein the texturable surface 20 includes protrusions 22 as shown in FIG. 2D. In one exemplary embodiment, the activation condition responsive materials 50 includes a xerogel material 54 and the activation fluid 51 is an organic or an inorganic liquid, such as, for example moisture in the form of liquid water. Any suitable xerogel may be employed, including those having a porosity of about 25% and a surface area of about 150-900 m²/g and a pore size of about 1-10 nm. In another exemplary embodiment, the activation condition responsive material 50 includes an SMP material 53 that is molded to provide at least one precursor protrusion 22′ (FIG. 2A) from the pocket 14 and then formed, such as by being compressed using a heated platen 90 (or two opposing platens 90 as shown in FIG. 1B) to provide a substantially planar surface with the surface 13 of body 12 (FIG. 2B), whereupon a layer of fluid permeable membrane 16 is incorporated into the body 12 by being bonded to the surface 13 (FIG. 2C).

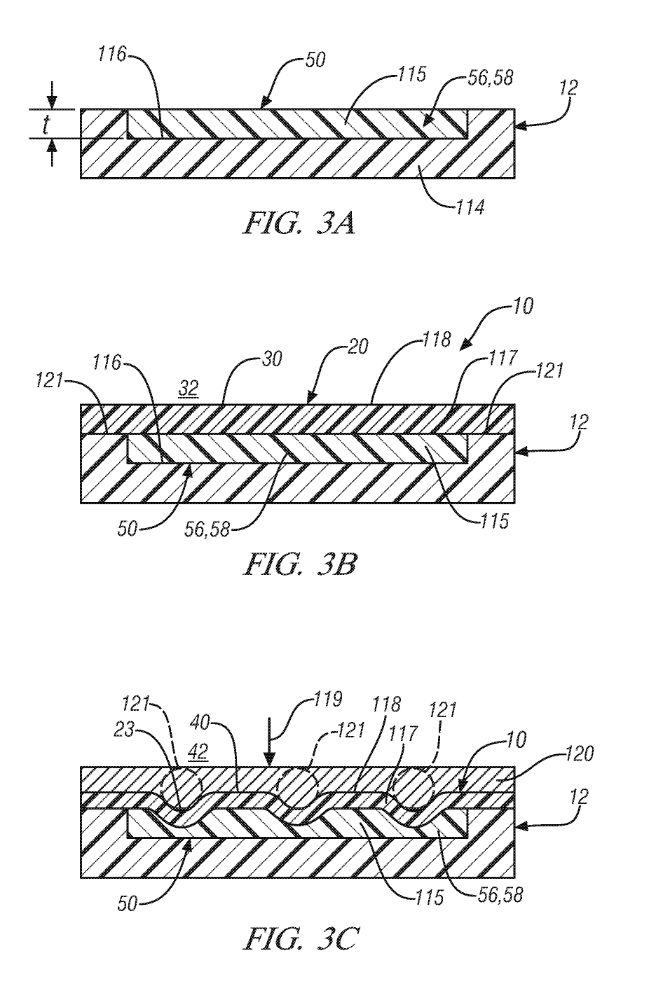

Referring to FIGS. 3A-3C, an article 10 that includes selectively texturable surface 20 comprises a body 12. Body 12 includes a rigid backing 114. Rigid backing may include any suitable rigid backing material, including various metals, polymers, ceramics, or composites, or a combination thereof. A layer 115 of activation condition responsive material 50 is disposed on an outer surface 116 the rigid backing 114 as shown in FIG. 3A. The layer 115 may have any suitable thickness (t) to provide the desired ability to texture texturable surface 20 as described herein. The thickness (t) may be constant or variable over the outer surface 116. Activation condition responsive material 50 may include a thixotropic material 56 or a shear thickening (or thinning) fluid 58 that is responsive to an activation condition comprising a change in a shear stress applied to the material. An elastically flexible or deformable layer 118 is disposed over the layer 115 of activation condition responsive material 50 and attached to an upper surface 121 of the backing 114 as shown in FIG. 3B. Elastically flexible layer 118 may include any suitable elastically flexible material 117, including various metals, polymers, ceramics or composites, or a combination thereof. This represents a first activation condition 32 and a first surface texture 30, wherein the texturable surface 20 is substantially planar as shown in FIG. 3B. Suitable activation condition responsive materials 50 are configured to provide a change in shape upon application of a suitable shear stress 119 by an object 120 as shown in FIG. 3C. Upon application of shear stress 119, the texturable surface 20 is exposed to the second activation condition 42 and assumes the second surface texture 40 having recesses 23. The response of texturable surface 20 may be time dependent due to the nature of the thixotropic material 56 or a shear thickening fluid 58. Shear stress 119 may be applied by any suitable object 120, including an article of manufacture, a machine or a human user. In an exemplary embodiment, the article 10 is a flat sheet and the object is a platen 120. In another exemplary embodiment, the article 10 is a steering wheel and the objects are the fingers 121 of a hand of a human user pressing against the wheel. Upon release of the shear stress 119, the elastically flexible layer 118 exerts a combination of normal and shear forces that are configured to gradually return the article 10 to the first activation condition and the configuration illustrated in FIG. 3B; hence, the texturable surface 20 is reversible. The elastically flexible layer 118 may be disposed over layer 115 by any suitable means for disposition, including attaching it to a portion of the body 12, such as upper surface 121.

Referring to FIG. 5, a method 200 of using an article 12 that includes a selectively texturable surface 20 is described. The method 200 includes: forming 210 an article 12 having a selectively texturable surface 20 having a first surface texture 30 associated with a first activation condition 32 and a second surface texture 40 associated with a second activation condition 42 as described herein, wherein the first surface texture 30 is different than the second surface texture 40, from an activation condition responsive material 50 comprising an active material 52, a xerogel material 54, thixotropic material 56 or a shear thickening material 58, or a combination thereof, that is operatively associated with the selectively texturable surface 20 and configured to provide the first surface texture 30 in the first activation condition 32 and the second surface texture 40 in the second activation condition 42. The method 200 also includes exposing 220 the selectively texturable surface 20 to one of the first activation condition 32 or the second condition 42 to provide one of the first surface texture 30 or the second surface texture 40, respectively. The method 200 may also include exposing 230 the article 12 wherein the selectively texturable surface 20 is exposed to the other one of the first activation condition 32 or the second activation condition 42 to provide the other one of the first surface texture 30 or the second surface texture 40.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An article comprising a selectively texturable surface, comprising:
an article having a selectively texturable surface, the selectively texturable surface having a first surface texture associated with a first activation condition and a second surface texture associated with a second activation condition, wherein the first surface texture is different than the second surface texture; and
an activation condition responsive material comprising an active material, a xerogel, a thixotropic material or a shear thickening material, or a combination thereof, that is operatively associated with the selectively texturable surface and configured to selectively provide the first surface texture in the first activation condition and the second surface texture in the second activation condition.

2. The article of claim 1, wherein the activation condition responsive material comprises an active material that is responsive to an activation condition comprising a change in a fluid content.

3. The article of claim 2, wherein the fluid comprises moisture, and wherein the active material has a first condition associated with a first moisture content and a second condition associated with a second moisture content, wherein the first moisture content is configured to provide the first surface texture and the second moisture content is configured to provide the second surface texture.

4. The article of claim 3, wherein the first surface texture or the second surface texture comprise a macroscopic aspect or a microscopic aspect of the selectively texturable surface.

5. The article of claim 3, wherein the first surface texture is greater than the second surface texture and the first moisture content is greater than the second moisture content.

6. The article of claim 3, wherein the first surface texture is greater than the second surface texture and the first moisture content is less than the second moisture content.

7. The article of claim 3, wherein the texturable surface comprises the active material.

8. The article of claim 7, wherein the active material comprises a shape memory polymer.

9. The article of claim 1, wherein the texturable surface comprises a moisture permeable layer and the activation condition responsive material is operatively associated with the moisture permeable layer.

10. The article of claim 9, wherein the activation condition responsive material is in operative contact with the moisture permeable layer.

11. The article of claim 9, wherein the activation condition responsive material comprises a shape memory polymer or xerogel, or a combination thereof.

12. The article of claim 1, wherein the activation condition responsive material comprises a thixotropic material or a shear thickening fluid that is responsive to an activation condition comprising a change in a shear stress applied to the material.

13. The article of claim 12, wherein the activation condition responsive material comprises a thixotropic material and the thixotropic material has a first condition associated with a first shear stress and a second condition associated with a second shear stress, wherein the first condition is configured to provide the first surface texture and the second condition is configured to provide the second surface texture.

14. The article of claim 13, wherein the texturable surface comprises an elastically flexible layer and the thixotropic material is operatively associated with the elastically flexible layer.

15. The article of claim 14, wherein the thixotropic material comprises a layer that is in operative contact with the elastically flexible layer.

16. The article of claim 15, further comprising a rigid backing member, wherein the thixotropic material layer is disposed on the rigid backing member.

17. An article comprising a moisture-activated, selectively texturable surface, comprising:
an article having a selectively texturable surface, the selectively texturable surface having a first surface texture associated with a first moisture content proximate the surface and a second surface texture associated with a second moisture content proximate the surface, wherein the first surface texture is different than the second surface texture; and
an active material operatively associated with the selectively texturable surface, the active material having a first condition associated with the first moisture content and a second condition associated with the second moisture content, wherein the first condition is configured to selectively provide the first surface texture and the second condition is configured to provide the second surface texture.

18. The article of claim 17, wherein the article is a tire and the texturable surface comprises a tire tread.

19. A method of making an article comprising a selectively texturable surface, comprising:
forming an article having a selectively texturable surface, the selectively texturable surface having a first surface texture associated with a first activation condition and a second surface texture associated with a second activation condition wherein the first surface texture is different than the second surface texture, from an activation condition responsive material comprising an active material, a xerogel, a thixotropic material or a shear thickening material, or a combination thereof, that is operatively associated with the selectively texturable surface and configured to provide the first surface texture in the first activation condition and the second surface texture in the second activation condition; and
exposing the selectively texturable surface to one of the first activation condition or the second activation condition to provide one of the first surface texture or the second surface texture.

20. The method of claim 19, further comprising:
exposing the article wherein the selectively texturable surface is exposed to the other one of the first activation condition or the second activation condition to provide the other one of the first surface texture or the second surface texture.
